(19) United States
(12) Patent Application Publication
(10) Pub. No.: US 2023/0044694 A1
(43) Pub. Date: Feb. 9, 2023

(54) ACTION EVALUATION SYSTEM, ACTION EVALUATION METHOD, AND RECORDING MEDIUM

(71) Applicant: Hitachi, Ltd., Tokyo (JP)

(72) Inventors: Masakazu TAKAHASHI, Tokyo (JP); Masashi EGI, Tokyo (JP); Yuxin LIANG, Tokyo (JP)

(73) Assignee: Hitachi, Ltd., Tokyo (JP)

(21) Appl. No.: 17/690,300

(22) Filed: Mar. 9, 2022

(30) Foreign Application Priority Data
Aug. 5, 2021 (JP) 2021-129131

(51) Int. Cl. G06Q 10/06

(52) U.S. Cl. CPC G06Q 10/06375; G06Q 10/06398; G06Q 10/06393

(57) ABSTRACT

To provide an action evaluation system capable of more efficiently planning a new action based on an execution result of a test for limited action conditions. A condition change tracking unit determines, based on execution result information obtained by executing a test related to an action for an action target having a predetermined action condition, a condition change which is a change in the action condition before and after the test. A result verification unit calculates, based on the execution result information, an evaluation value obtained by evaluating an effect of the action. A reward distribution unit calculates a change contribution degree which is a degree of contribution of the condition change to the evaluation value.

### BACKGROUND OF THE INVENTION

### 1. Field of the Invention

This disclosure relates to an action evaluation system, an action evaluation method, and a recording medium.

### 2. Description of the Related Art

In a company or the like, an action that acts on an evaluation indicator, such as a key performance indicator (KPI), is being implemented in order to improve business. Further, in recent years, it is required not only to implement the action but also to evaluate an effect of the implemented action and to utilize an evaluation result for planning a new action.

JP-A-2019-079104 (PTL 1) and JP-A-2020-102206 (PTL 2) disclose a technique for performing an AB test as a test for evaluating an effect of an action. The AB test is a test for evaluating the effect of the action by dividing a plurality of action targets into two groups, implementing different actions for each group, or implementing the action only on one group, and comparing implementation results in each group.

In order to utilize an execution result of a test such as the AB test for planning the new action, it is useful to execute the test for each action condition provided by the action target. However, in reality, due to restrictions of such as cost, an action that can be implemented is restricted, and a test for a sufficient number of action conditions may be not executed. In this case, it is difficult to accurately evaluate the effect of the action, and it is difficult to utilize the execution result of the test for planning the new action.

In the technique described in PTL 1 and PTL 2, it is not considered that the test cannot be executed for a sufficient number of action conditions.

### SUMMARY OF THE INVENTION

An object of the present invention is to provide an action evaluation system, an action evaluation method, and a program capable of more efficiently planning a new action based on an execution result of a test for limited action conditions.

An action evaluation system according to one aspect of this disclosure, including: a tracking unit configured to determine, based on an execution result obtained by executing a test related to an action for an action target having a predetermined action condition, a condition change which is a change in the action condition before and after the test; a verification unit configured to calculate, based on the execution result, an evaluation value obtained by evaluating an effect of the action; and a distribution unit configured to calculate a change contribution degree which is a degree of contribution of the condition change to the evaluation value.

According to the invention, a new action can be more efficiently planned based on the execution result of the test for the limited action conditions with respect to the evaluation value obtained by evaluating the effect of the action.

### BRIEF DESCRIPTION OF THE DRAWINGS

FIG. 1 is a block diagram showing a functional configuration of a planning support system according to an embodiment of this disclosure.

FIG. 2 is a diagram showing an example of execution result information.

FIG. 3 is a diagram showing an example of condition information.

FIG. 4 is a diagram showing an example of condition change result information.

FIG. 5 is a diagram showing an example of action implementation result information.

FIG. 6 is a diagram showing an example of reward distribution result information.

FIG. 7 is a diagram showing an example of action effect prediction information.

FIG. 8 is a sequence chart illustrating an overall process of the planning support system.

FIG. 9 is a flowchart illustrating the overall process of the planning support system.

FIG. 10 is a flowchart illustrating an example of a condition change tracking process.

FIG. 11 is a flowchart illustrating an example of a result verification process.

FIG. 12 is a flowchart illustrating an example of a reward distribution process.

FIG. 13 is a flowchart illustrating an example of a new action planning support process.

FIG. 14 is a flowchart illustrating an example of an environment contribution prediction support process.

FIG. 15 is a flowchart illustrating an example of a condition change environment contribution prediction support process.

FIG. 16 is a diagram showing an example of a new action planning support screen.

FIGS. 17A and 17B are diagrams showing an example of a prediction support screen.

FIGS. 18A and 18B are diagrams showing another example of the prediction support screen.

### DESCRIPTION OF THE PREFERRED EMBODIMENTS

Hereinafter, embodiments of this disclosure will be described with reference to the drawings.

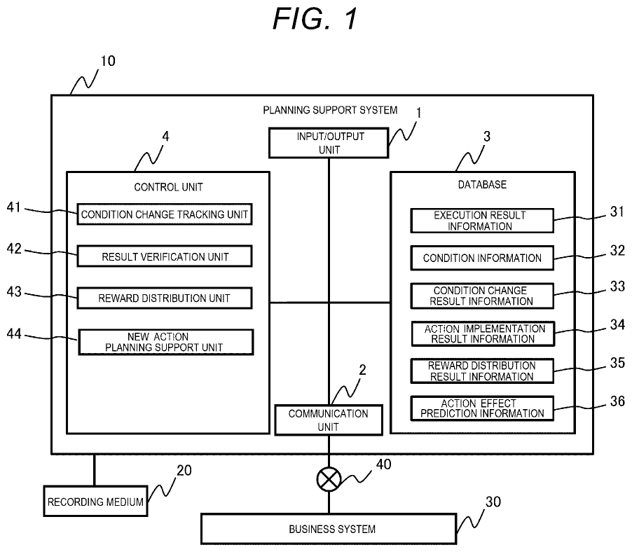

FIG. 1 is a block diagram showing a functional configuration of a planning support system according to an embodiment of this disclosure. A planning support system 10 shown in FIG. 1 is implemented by, for example, a computer system including a processor (a computer) and a memory (both not shown). In this case, each component and each function of the planning support system 10 described below are realized, for example, by the processor reading a computer program and executing the read computer program. The computer program can be recorded on a computer-readable recording medium 20. The recording medium 20 is, for example, a semiconductor memory, a magnetic disk, an optical disk, a magnetic tape, a magneto-optical disk, or the like.

The planning support system 10 is also called an action evaluation system, and is a system that evaluates an effect of an evaluation target action based on an execution result obtained by executing a test related to the evaluation target action, which is an action to be evaluated, and supports planning of a new action based on an evaluation result. In the present embodiment, a “coupon distribution” in which a coupon related to a predetermined target product (for example, a rice ball) (for example, a coupon for discounting a price of the target product or a coupon for free of the target product, or the like) is distributed to a customer who is an action target is described as an example of the evaluation target action, but the evaluation target action is not limited to the “coupon distribution”. The test is an AB test in which the evaluation target action is implemented on one of two groups obtained by dividing a plurality of action targets, and a reference action is implemented on the other group. The reference action may be a non-action in which no action is performed, and in the present embodiment, the reference action is the non-action.

The planning support system 10 includes an input/output unit 1, a communication unit 2, a database 3, and a control unit 4.

The input/output unit 1 has a function of receiving various types of information from a user who uses the planning support system 10, and a function of outputting various types of information to the user. The user is an action executor who executes the AB test, an action planner who plans a new action, or the like. The action executor and the action planner may be the same person.

The communication unit 2 communicates with an external system. In the example shown in FIG. 1, the communication unit 2 communicates, via a network 40, with a business system 30 that performs various processes related to business.

The database 3 stores various types of information used and generated by the control unit 4. In the example shown in FIG. 1, the database 3 stores execution result information 31, condition information 32, condition change result information 33, action implementation result information 34, reward distribution result information 35, and action effect prediction information 36. Hereinafter, the information is described as having a table structure, but may not have a table structure.

The execution result information 31 indicates the execution result obtained by executing the AB test. The condition information 32 indicates an action condition which is an attribute of the action target. The condition change result information 33 indicates a condition change which is a change in action condition before and after execution of the AB test.

The action implementation result information 34 indicates an action evaluation result which is the evaluation result obtained by evaluating the effect of the evaluation target action. The reward distribution result information 35 indicates a calculation result obtained by calculating, for each condition change, a change contribution degree, which is a degree of contribution of the condition change to the action evaluation result. The action effect prediction information 36 indicates a prediction result obtained by predicting an effect of a new action candidate, which is a candidate of a new action to be newly implemented.

The control unit 4 performs an evaluation process of evaluating the effect of the evaluation target action based on the execution result information 31 and the condition information 32 stored in the database 3, and a prediction process of predicting the effect of the new action candidate by using a process result of the evaluation process. The condition change result information 33, the action implementation result information 34, and the reward distribution result information 35 is information generated in the evaluation process, and the action effect prediction information 36 is information generated in the prediction process.

In the example shown in FIG. 1, the control unit 4 includes a condition change tracking unit 41, a result verification unit 42, a reward distribution unit 43, and a new action planning support unit 44.

The condition change tracking unit 41 is a tracking unit that determines, based on the database 3, the condition change, which is the change in the action condition of the action target before and after the execution of the AB test, and generates the condition change result information 33 indicating the condition change.

The result verification unit 42 is a verification unit that evaluates the effect of the evaluation target action based on the database 3, and generates the action implementation result information 34 indicating the action evaluation result, which is the evaluation result.

The reward distribution unit 43 is a distribution unit that calculates, based on the database 3, for each condition change, the change contribution degree, which is the degree of contribution of the condition change to an action evaluation value result, and generates the reward distribution result information 35 indicating the calculation result.

The new action planning support unit 44 is an action support unit that predicts the effect of the new action candidate based on the database 3, and generates the action effect prediction information 36 indicating the prediction result.

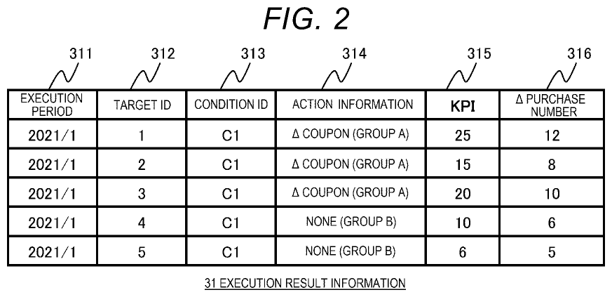

FIG. 2 is a diagram showing an example of the execution result information 31. The execution result information 31 shown in FIG. 2 includes columns 311 to 316.

The column 311 stores an execution period during which the AB test is executed. The column 312 stores a target ID, which is identification information for identifying the action target. The column 313 stores a condition ID for identifying the action condition. The column 314 stores action information related to the action implemented on the action target by the AB test. The action information indicates whether the evaluation target action (the coupon distribution) is implemented (whether the evaluation target action is implemented or the reference action is implemented). In the example shown in FIG. 2, any one of a “Δ coupon” indicating that the coupon related to the target product (the rice ball), which is the evaluation target action, is distributed, and a “none” indicating that the coupon is not distributed (the action is not implemented) is shown as the action information. A set of action targets to which the coupon is distributed may be referred to as a group A, and a set of action targets to which the coupon is not distributed may be referred to as a group B.

The column 315 stores a KPI as an evaluation value obtained by evaluating the effect of the AB test on the action target. The column 316 stores the number (indicated as “Δ purchase number” in the FIG. 2) of the target product (the rice ball) that are purchased after the AB test, as the effect due to the AB test on the action target. The purchase number may be, for example, the number of the target product purchased by using the coupon, the number of the target product purchased within a predetermined period after the distribution of the coupon, or the like. The KPI is a value calculated based on the purchase number of the target product. A calculation formula for calculating the KPI is not limited here.

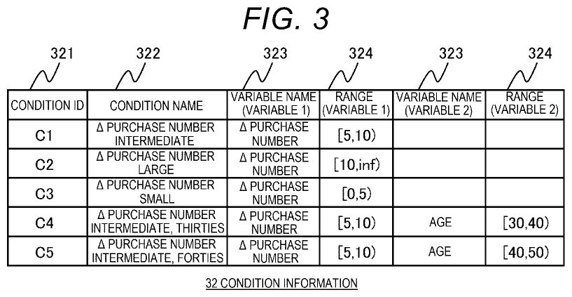

FIG. 3 is a diagram showing an example of the condition information 32. The condition information 32 shown in FIG. 3 includes columns 321 to 324.

The column 321 stores the condition ID for identifying the action condition. The column 322 stores a condition name, which is a name of the action condition. The columns 323 and 324 are provided for each variable contained in the action condition. The column 323 stores a variable name for identifying the variable, and the column 324 stores a range of the variable. The example shown in FIG. 3 shows, as the variables, a variable 1 which is the A purchase number and a variable 2 which is an age of the action target, but other variables may be used. The Δ purchase number is the number of the target product purchased by the action target during a predetermined period before the AB test. “X, Y” in the range of the variable indicates that the variable is X or more and Y or less. A case where Y is “inf” indicates that Y is X or more. Each action condition may have only one of the variables 1 and 2. Further, the identical action target may have a plurality of action conditions. For example, in the example shown in FIG. 3, a customer in thirties of which the A purchase number is 5 or more and 10 or less has action conditions corresponding to the condition IDs “C1” and “C4”.

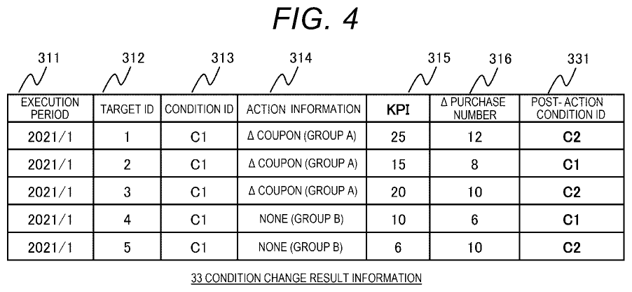

FIG. 4 is a diagram showing an example of the condition change result information 33. The condition change result information 33 shown in FIG. 4 is information obtained by adding a column 331 to the execution result information 31 (the columns 311 to 316).

The column 331 stores condition change information indicating the condition change which is the change in the action condition before and after the execution of the AB test. In the present embodiment, a post-action condition ID, which is a condition ID of a post-action condition is stored as the condition change information. The post-action condition is an action condition of the action target after the execution of the AB test. For example, if the Δ purchase number after the execution of the AB test of the customer having the action condition corresponding to the condition ID “C1” is 12, the post-action condition ID is “C2”. A case where the post-action condition ID is the same as an original condition ID indicates that the action condition is not changed.

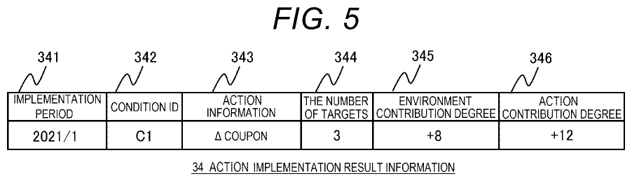

FIG. 5 is a diagram showing an example of the action implementation result information 34. The action implementation result information 34 shown in FIG. 5 includes columns 341 to 346.

The column 341 stores an implementation period (the same as the execution period during which the AB test is executed) during which the evaluation target action is implemented. The column 342 stores a condition ID of an evaluation target condition, which is an action condition of the action target on which the evaluation target action is to be implemented. The column 343 stores the action information indicating the evaluation target action. The column 344 stores the number of targets, which is the number of action targets which have the evaluation target condition and on which the evaluation target action is implemented. The columns 345 and 346 store evaluation values which are the evaluation results obtained by evaluating the effect of the evaluation target action.

Specifically, the column 345 stores an environment contribution degree indicating the degree of contribution of the environment to the effect of the evaluation target action, and the column 346 stores an action contribution degree obtained by evaluating contribution of the action itself to the effect of the evaluation target action. The contribution of the environment is an effect, among the effects, generated due to an influence on the evaluation target action produced by an environment change separately from the action. The environment change includes, for example, changes in market and natural conditions.

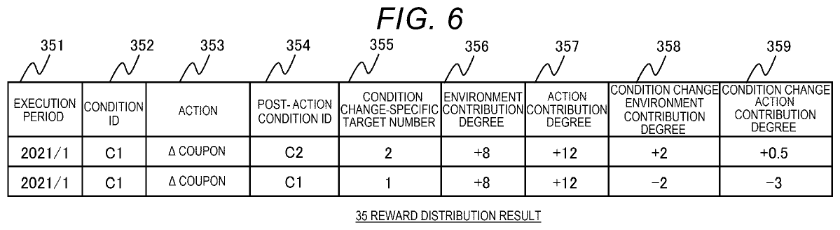

FIG. 6 is a diagram showing an example of the reward distribution result information 35. The reward distribution result information 35 shown in FIG. 6 includes columns 351 to 359.

The column 351 stores the implementation period during which the evaluation target action is implemented. The column 352 stores the condition ID of the evaluation target condition. The column 353 stores the action information indicating the evaluation target action. The column 354 stores the post-action condition ID as the condition change information. The column 355 stores a condition change-specific target number, which is the number of action targets which have the evaluation target condition and the post-action condition and on which the evaluation target action is implemented (that is, the number of action targets of which the action condition is changed from the evaluation target condition to the post-action condition due to the evaluation target action). The column 356 stores the environment contribution degree indicating the degree of contribution of the environment to the effect of the evaluation target action, and the column 357 stores the action contribution degree obtained by evaluating the contribution of the action itself to the effect of the evaluation target action. The columns 358 and 359 store the change contribution degrees, which are the degrees of the contribution of the condition change to the action evaluation result. Specifically, the column 358 stores a condition change environment contribution degree, which is a degree of contribution of the environment to the condition change, and the column 359 stores a condition change action contribution degree, which is a degree of contribution of the action to the condition change.

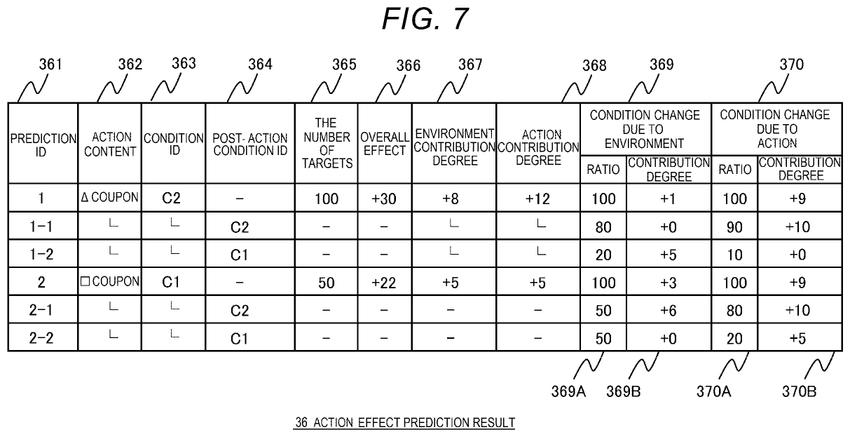

FIG. 7 is a diagram showing an example of the action effect prediction information 36. The action effect prediction information 36 shown in FIG. 7 includes columns 361 to 370.

The column 361 stores a prediction ID for identifying a prediction result of an effect of a new action candidate. The prediction ID includes an ID (“1”, “2”, or the like) for identifying a prediction result of an overall effect, which is an effect of an entire new action candidates and a prediction result (“1-1”, “1-2”, or the like) of a condition change-specific effect, which is an effect achieved by each condition change in the new action candidate. The column 362 stores an action content of the new action candidate. The column 363 stores a condition ID of an action condition of an implementation target on which the new action candidate is to be implemented. The column 364 stores a post-action condition ID indicating a condition change of the condition change-specific effect. The column 365 stores the number of targets, which is the number of action targets on which the new action candidate is to be implemented. The column 366 stores an overall effect, which is an effect of the entire new action candidates. The column 367 stores an environment contribution degree, which is a degree of contribution of the environment to the overall effect. The column 368 stores an action contribution degree, which is a degree of contribution of to the action to the overall effect.

The column 369 stores information related to the condition change contribution degree due to the environment with respect to the overall effect. Specifically, the column 369 includes a column 369A that stores a ratio of the condition change with respect to the overall effect and a column 369B that stores the contribution degree of the condition change. The column 370 stores information related to a condition change contribution degree of the action with respect to the overall effect. Specifically, the column 370 includes a column 370A that stores a ratio of the condition change with respect to the overall effect, and a column 370B that stores the contribution degree of the condition change.

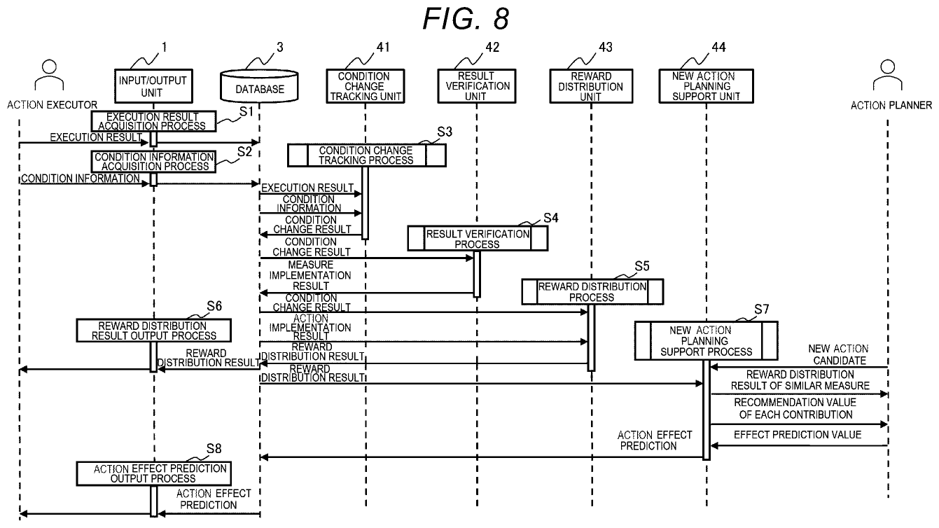

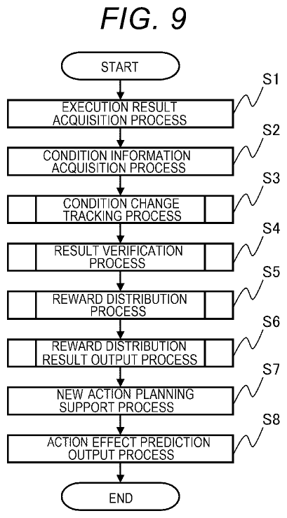

FIG. 8 is a sequence chart illustrating an overall process of the planning support system 10, and FIG. 9 is a flowchart illustrating the overall process of the planning support system 10.

In the overall process, first, the input/output unit 1 executes an execution result acquisition process of receiving the execution result information 31 from the action executor and storing the execution result information 31 in the database 3 (step S1). Further, the input/output unit 1 executes a condition information acquisition process of receiving the condition information 32 from the action executor and storing the condition information 32 in the database 3 (step S2). At least one of the execution result information 31 and the condition information 32 may be stored in the database 3 via the communication unit 2.

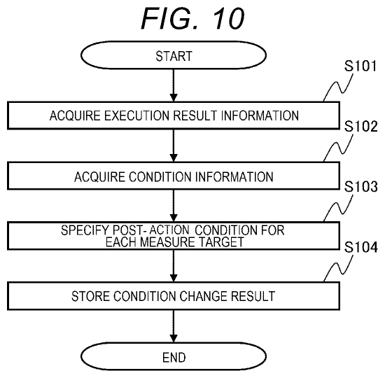

Thereafter, the condition change tracking unit 41 of the control unit 4 executes a condition change tracking process of generating the condition change result information 33 based on the execution result information 31 and the condition information 32 stored in the database 3, and storing the condition change result information 33 in the database 3 (see FIG. 10) (step S3).

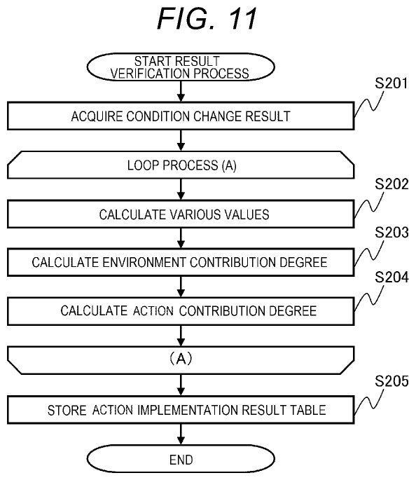

Subsequently, the result verification unit 42 executes a result verification process of generating the action implementation result information 34 based on the condition change result information 33 stored in the database 3, and storing the action implementation result information 34 in the database 3 (see FIG. 11) (step S4).

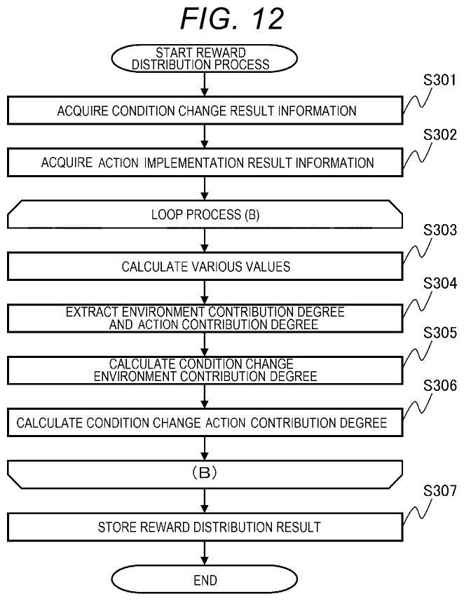

Next, the reward distribution unit 43 executes a reward distribution process of generating the reward distribution result information 35 based on the condition change result information 33 and the action implementation result information 34 stored in the database 3, and storing the reward distribution result information 35 in the database 3 (see FIG. 12) (step S5). Then, the input/output unit 1 executes a reward distribution result output process of outputting the reward distribution result information 35 stored in the database 3 (step S6).

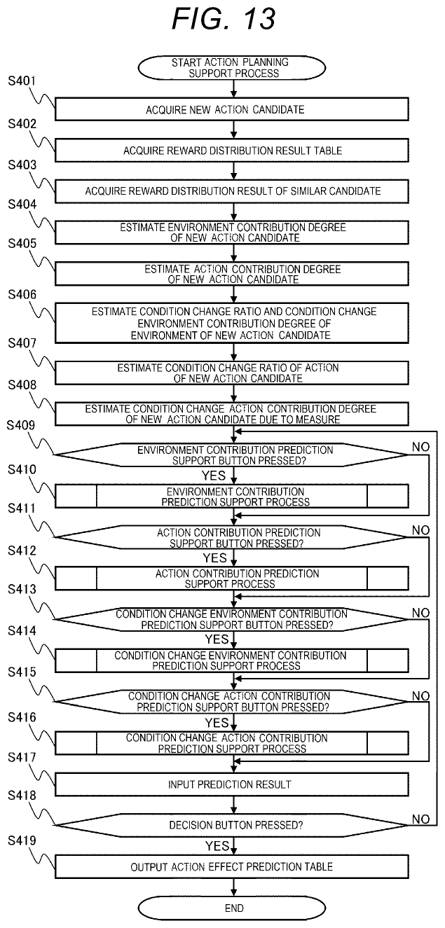

The new action planning support unit 44 executes a new action planning support process of generating the action effect prediction information 36 based on the reward distribution result information 35 stored in the database 3, and storing the action effect prediction information 36 in the database 3 (see FIG. 13) (step S7). In the new action planning support process, the new action planning support unit 44 can receive the new action candidate and an effect prediction value from the action planner via the input/output unit 1 or the communication unit 2, and further output a reward distribution result and a recommendation value of each contribution to the action planner.

Then, the input/output unit 1 executes an action effect prediction output process of outputting the action effect prediction information 36 stored in the database 3 (step S8), and the process ends.

FIG. 10 is a flowchart illustrating an example of the condition change tracking process executed by the condition change tracking unit 41.

In the condition change tracking process, first, the condition change tracking unit 41 acquires the execution result information 31 from the database 3 (step S101), and then acquires the condition information 32 from the database 3 (step S102).

The condition change tracking unit 41 adds the column 331 that stores the post-action condition ID to the execution result information 31 to generate the condition change result information 33. The condition change tracking unit 41 specifies, based on the condition information 32, for each combination of the execution period and the target ID stored in the columns 311 and 312 of the execution result information 31, the action condition of the action target identified by the target ID after the execution of the AB test as the post-action condition, and stores the condition ID of the post-action condition as the post-action condition ID in the added column 331 (step S103). If the post-action condition is not defined (different from a predefined action condition), the condition change tracking unit 41 may newly define the post-action condition.

The condition change tracking unit 41 stores the condition change result information 33 storing the post-action condition ID in the database 3 (step S104), and ends the condition change tracking process.

FIG. 11 is a flowchart illustrating an example of the result verification process executed by the result verification unit 42.

In the result verification process, first, the result verification unit 42 acquires the condition change result information 33 from the database 3 (step S201).

The result verification unit 42 executes a loop process A in which processes of steps S202 to S204 are repeated for each combination of the execution period and the condition ID in the condition change result information 33.

In the loop process A, first, based on the condition change result information 33, the result verification unit 42 calculates the number of target IDs in the group A in a target combination as the number of targets n_{A} in the group A, calculates the number of target IDs in the group B as the number of targets n_{B} in the group B, calculates an average value of the KPIs of the group A as a KPI average value y_{A} of the group A, and calculates an average value of the KPIs of the group B as a KPI average value y_{B} of the group B (step S202).

The result verification unit 42 calculates the KPI average value y_{B} of the group B as the environment contribution degree of the evaluation target action (step S203).

The result verification unit 42 calculates a value (y_{A}−y_{B}) obtained by subtracting the KPI average value y_{B} of the group B from the KPI average value y_{A} of the group A as the action contribution degree of the evaluation target action (step 204). Then, the result verification unit 42 adds, to the action implementation result information 34, a record including the execution period and the condition ID of the target combination, the action information indicating the evaluation target action, the calculated number of targets n_{A} in the group A, the environment contribution degree, and the action contribution degree.

When the processes of steps S202 to S204 are completed for all combinations, the result verification unit 42 exits the loop process A, stores the action implementation result information 34 in the database 3 (step S205), and ends the result verification process.

FIG. 12 is a flowchart illustrating an example of the reward distribution process executed by the reward distribution unit 43.

In the reward distribution process, first, the reward distribution unit 43 acquires the condition change result information 33 from the database 3 (step S301), and further acquires the action implementation result information 34 from the database 3 (step S302).

The reward distribution unit 43 executes a loop process B in which processes of steps S303 to S306 are repeated for each combination of the execution period, the condition ID, and the post-action condition ID in the condition change result information 33.

In the loop process B, based on the condition change result information 33, the reward distribution unit 43 calculates the number of target IDs in the group A in the target combination as the number of targets n_{A} in the group A, and a ratio p_{A} of the number of targets in the group A with respect to the total number of targets, calculates the number of target IDs in the group B as the number of targets n_{B} in the group B, and a ratio p_{B} of the number of targets in the group B with respect to the total number of targets, calculates the average value of the KPI of the group A as the KPI average value y_{A} of the group A, and calculates the average value of the KPI of the group B as the KPI average value y_{B} of the group B (step S303).

The reward distribution unit 43 acquires a record, which includes an execution period and a condition ID the same as the execution period and the condition ID of the target combination, from the action implementation result information 34, and extracts environment contribution degree ζ and action contribution degree ξ included in the record (step S304).

The reward distribution unit 43 calculates a value (y_{B}−ζ) obtained by subtracting the environment contribution degree ζ from the KPI average value y_{B} of the group B calculated in step S303 as the condition change environment contribution degree in the target combination (step S305).

The reward distribution unit 43 calculates a value (y_{A}−y_{B}−ξ) obtained by subtracting the KPI average value y_{B} of the group B and the action contribution degree ξ from the KPI average value y_{A} of the group A calculated in step S303 as the condition change action contribution degree in the target combination (step S306). Then, the reward distribution unit 43 adds, to the reward distribution result information 35, a record including the execution period, the condition ID, and the post-action condition ID of the target combination, the action information indicating the evaluation target action, the acquired environment contribution degree ζ and the action contribution degree ξ, the calculated number n_{A} of targets in the group A, the condition change environment contribution degree, and the condition change action contribution degree. At this time, the number n_{A} of targets in the group A is stored as the condition change-specific target number in the reward distribution result information 35.

When the processes of steps S303 to S306 are completed for all combinations, the reward distribution unit 43 exits the loop process B, stores the reward distribution result information 35 in the database 3 (step S307), and ends the result verification process.

FIG. 13 is a flowchart illustrating an example of the new action planning support process executed by the new action planning support unit 44.

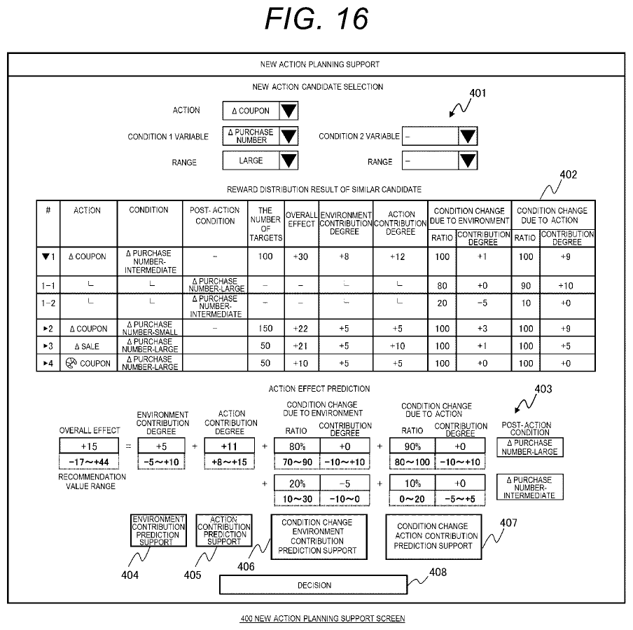

In the new action planning support process, the new action planning support unit 44 displays a new action planning support screen (see FIG. 16) for supporting planning of a new action, and receives new action candidate information from the action planner via the new action planning support screen (step S401). The new action candidate information includes action information indicating the new action candidate and action condition of the action target on which the new action candidate is to be implemented.

The new action planning support unit 44 acquires the reward distribution result information 35 from the database 3 (step S402).

The new action planning support unit 44 acquires, as a reward distribution result of a similar candidate similar to the new action candidate, each record including the action information and at least one of the variable names of the action condition indicated by the new action candidate information from the reward distribution result information 35, and displays the acquired reward distribution result on the new action planning support screen (step S403).

The new action planning support unit 44 estimates, based on the reward distribution result of the similar candidate, an average value, a maximum value, and a minimum value, which are statistical values of an environment contribution degree of the similar candidate of which the variable name of the action condition matches that of the new action candidate, as an estimated value, an upper limit value, and a lower limit value of an environment contribution degree of the new action candidate, and displays the estimated value, the upper limit value, and the lower limit value on the new action planning support screen (step S404).

The new action planning support unit 44 estimates, based on the reward distribution result of the similar candidate, an average value, a maximum value, and a minimum value, which are statistical values of an action contribution degree of the similar candidate of which the action information matches that of the new action candidate, as an estimated value, an upper limit value, and a lower limit value of an action contribution degree of the new action candidate, and displays the estimated value, the upper limit value, and the lower limit value on the new action planning support screen (step S405).

The new action planning support unit 44 estimates, based on the reward distribution result of the similar candidate, for each condition change in the similar candidate of which the action conditions match those of the new action candidate, average values, maximum values, and minimum values, which are statistical values of a condition change ratio and the condition change environment contribution degree, as estimated values, upper limit values, and lower limit values of a condition change ratio and a condition change environment contribution degree of the environment of the new action candidate, and displays the estimated values, the upper limit values, and the lower limit values on the new action planning support screen (step S406). The condition change ratio is a ratio of the similar candidate having the condition change with respect to all similar candidates.

The new action planning support unit 44 estimates, based on the reward distribution result, for each condition change in the similar candidate of which the action information matches that of the new action candidate, an average value, a maximum value, and a minimum value, which are statistical values of the condition change ratio, as an estimated value, an upper limit value, and a lower limit value of a condition change ratio of the new action candidate, and displays the estimated value, the upper limit value, and the lower limit value on the new action planning support screen (step S407).

The new action planning support unit 44 estimates, based on the reward distribution result, for each condition change in the similar candidate of which the action conditions match those of the new action candidate, an average value, a maximum value, and a minimum value, which are statistical values of the condition change action contribution degree, as an estimated value, an upper limit value, and a lower limit value of a condition change action contribution degree of the new action candidate, and displays the estimated value, the upper limit value, and the lower limit value on the new action planning support screen (step S408).

The new action planning support unit 44 determines whether an environment contribution prediction support button on the new action planning support screen is pressed (step S409).

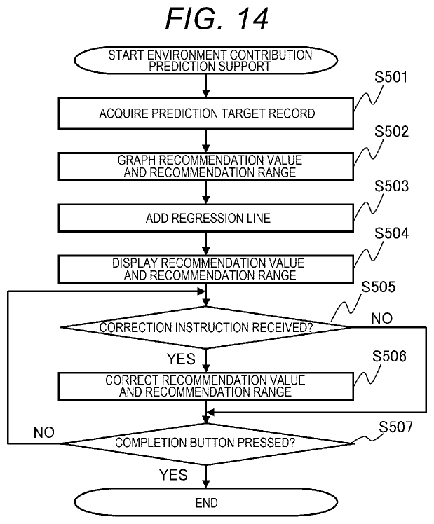

If the environment contribution prediction support button is pressed, the new action planning support unit 44 executes an environment contribution prediction support process (see FIG. 14) (step S410).

If the environment contribution prediction support button is not pressed and when the environment contribution prediction support process is ended, the new action planning support unit 44 determines whether an action contribution prediction support button on the new action planning support screen is pressed (step S411).

If the action contribution prediction support button is pressed, the new action planning support unit 44 executes an action contribution prediction support process (see FIG. 14) (step S412).

If the action contribution prediction support button is not pressed and when the action contribution prediction support process is ended, the new action planning support unit 44 determines whether a condition change environment contribution prediction support button on the new action planning support screen is pressed (step S413).

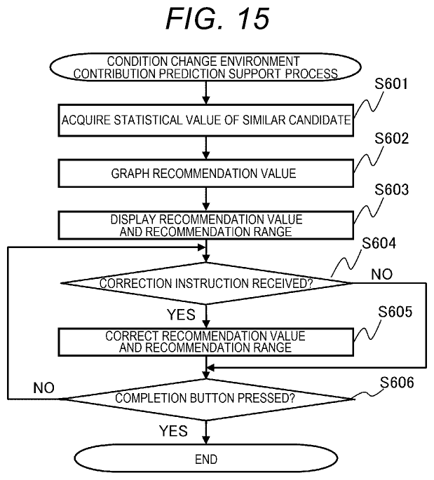

If the condition change environment contribution prediction support button is pressed, the new action planning support unit 44 executes a condition change environment contribution prediction support process (see FIG. 15) (step S414).

If the condition change environment contribution prediction support button is not pressed and when the condition change environment contribution prediction support process is ended, the new action planning support unit 44 determines whether a condition change action contribution prediction support button on the new action planning support screen is pressed (step S415).

If the condition change action contribution prediction support button is pressed, the new action planning support unit 44 executes a condition change action contribution prediction support process (see FIG. 15) (step S416).

If the condition change action contribution prediction support button is not pressed and when the condition change action contribution prediction support process is ended, the new action planning support unit 44 executes a prediction result correction and input process (step S417). In the prediction result correction and input process, the action planner can appropriately correct each of the displayed estimated values, upper limit values, and lower limit values.

Thereafter, the new action planning support unit 44 determines whether a decision button is pressed (step S418). If the decision button is not pressed, the new action planning support unit 44 returns to the process of step S409. Meanwhile, if the decision button is pressed, the new action planning support unit 44 generates the action effect prediction information 36 based on each value calculated in steps S403 to S408 and a correction result of step S417, stores the generated action effect prediction information 36 in the database 3 (step S419), and ends the new action planning support process.

FIG. 14 is a flowchart illustrating an example of the environment contribution prediction support process of step S410 illustrated in FIG. 13.

In the environment contribution prediction support process, the new action planning support unit 44 acquires, as a prediction target record, a record, in which a variable of an action condition matches that of a new action planning candidate, from the reward distribution result of the similar action (step S501). Based on the prediction target record, the new action planning support unit 44 calculates an aggregated value obtained by aggregating the environment contribution degree corresponding to the variable for each range of the variable of the action condition, and draws each aggregated value in a graph form (step S502). The new action planning support unit 44 performs regression analysis on each aggregated value, and adds regression lines to the graph (step S503).

The new action planning support unit 44 calculates the average value of the environment contribution degree of the similar candidate as a recommendation value (an estimated value) of an environment contribution degree of the new action, calculates a range from a lower limit value to an upper limit value of the environment contribution degree of the similar candidate of the new action as a recommendation range of the environment contribution degree of the new action, and displays the recommendation value and the recommendation range (step S504).

The new action planning support unit 44 determines whether a correction instruction of the recommendation value and the recommendation range is received from the user (step S505). If the correction instruction is received, the new action planning support unit 44 corrects the recommendation value and the recommendation range according to the correction instruction (step S506). Thereafter, the new action planning support unit 44 determines whether a completion button is pressed (step S507). If the correction instruction is not received, the new action planning support unit 44 skips step S506.

The new action planning support unit 44 ends the process if the completion button is pressed, or returns to the process of step S505 if the completion button is not pressed.

The action contribution prediction support process of step S412 illustrated in FIG. 13 is similar to the environment contribution prediction support process illustrated with reference to FIG. 14, and the “environment” may be read as the “action”.

FIG. 15 is a flowchart illustrating an example of the condition change environment contribution prediction support process of step S414 illustrated in FIG. 13.

In the condition change environment contribution prediction support process, the new action planning support unit 44 acquires average values, lower limit values, and upper limit values, which are statistical values of the condition change ratio and the condition change environment contribution degree, for each condition change in the similar candidate (step S601). For each condition change, the new action planning support unit 44 sets the average values of the condition change ratio and the condition change environment contribution degree as recommendation values of the condition change ratio and the condition change environment contribution degree of the new action candidate, and draws each recommendation value in a graph form (step S602).

For each post-action condition, the new action planning support unit 44 sets a range from the lower limit value to the upper limit value of the condition change ratio as a recommendation range of the condition change ratio of the new action candidate and sets a range from the lower limit value to the upper limit value of the condition change environment contribution degree as a recommendation range of the condition change environment contribution degree of the new action candidate, and displays the recommendation values and the recommendation ranges (step S603).

The new action planning support unit 44 determines whether a correction instruction of the recommendation value and the recommendation range is received from the user (step S604). If the correction instruction is received, the new action planning support unit 44 corrects the recommendation value and the recommendation range according to the correction instruction (step S605). Thereafter, the new action planning support unit 44 determines whether a completion button is pressed (step S606). If the correction instruction is not received, the new action planning support unit 44 skips step S605.

The new action planning support unit 44 ends the process if the completion button is pressed, or returns to the process of step S604 if the completion button is not pressed.

The condition change action contribution prediction support process of step S416 illustrated in FIG. 13 is similar to the condition change environment contribution prediction support process illustrated with reference to FIG. 15, and the “environment” may be read as the “action”.

FIG. 16 is a diagram showing an example of the new action planning support screen. The new action planning support screen 400 shown in FIG. 16 includes a new action candidate selection unit 401 for inputting the new action candidate information, a distribution display unit 402 for displaying the reward distribution result of the similar candidate, an action effect display unit 403 for displaying the prediction result of the effect of the new action candidate, an environment contribution prediction support button 404, an action contribution prediction support button 405, a condition change environment contribution prediction support button 406, a condition change action contribution prediction support button 407, and a decision button 408.

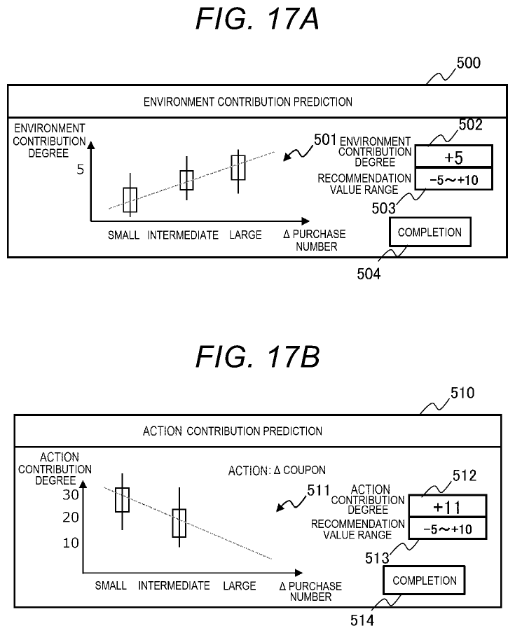

FIG. 17A is a diagram showing an example of an environment contribution prediction support screen, and FIG. 17B is a diagram showing an example of an action contribution prediction support screen.

An environment contribution prediction support screen 500 shown in FIG. 17A includes a graph 501 of the aggregated value of the environment contribution degree of the new action, a recommendation value 502 of the environment contribution degree of the new action, a recommendation range 503 of the environment contribution degree of the new action, and a completion button 504. An action contribution prediction support screen 510 shown in FIG. 17B includes a graph 511 of the aggregated value of the action contribution degree of the new action, a recommendation value 512 of the action contribution degree of the new action, a recommendation range 513 of the action contribution degree of the new action, and a completion button 514.

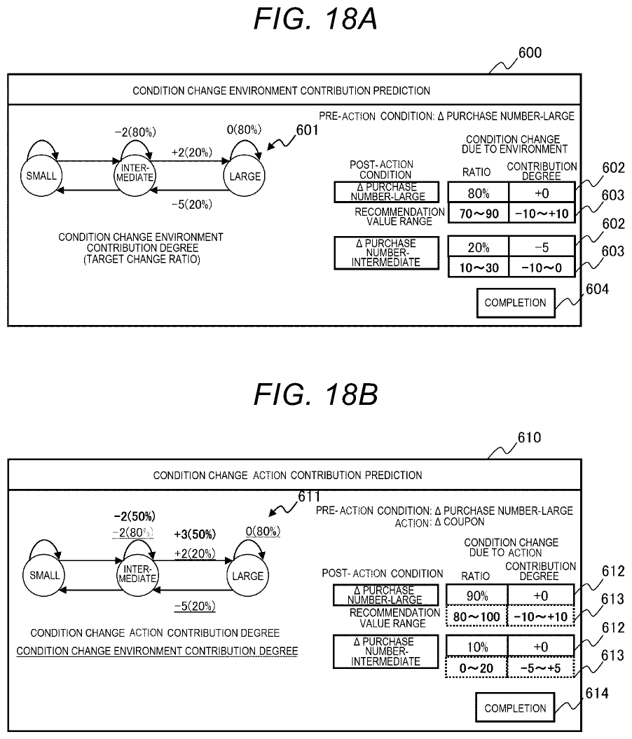

FIG. 18A is a diagram showing an example of a condition change environment contribution prediction support screen, and FIG. 18B is a diagram showing an example of a condition change action contribution prediction support screen.

A condition change environment contribution prediction support screen 600 shown in FIG. 18A includes a graph 601 of the recommendation values of the condition change ratio and the condition change environment contribution degree of the new action candidate, recommendation values 602 of the condition change ratio and the condition change environment contribution degree of the new action candidate, recommendation ranges 603 of the condition change ratio and the condition change environment contribution degree of the new action candidate, and a completion button 604. The recommendation values 602 and the recommendation ranges 603 are displayed for each condition after the action.

A condition change action contribution prediction support screen 610 shown in FIG. 18B includes a graph 611 of the recommendation values of the condition change ratio and the condition change action contribution degree of the new action candidate, recommendation values 612 of the condition change ratio and the condition change action contribution degree of the new action candidate, recommendation ranges 613 of the condition change ratio and the condition change action contribution degree of the new action candidate, and a completion button 614. The recommendation values 612 and the recommendation ranges 613 are displayed for each condition after the action. In the graph 611, the recommendation value of the condition change ratio and the recommendation value of the condition change environment contribution degree of the new action candidate may be shown together.

As described above, according to the present embodiment, the condition change tracking unit 41 determines, based on the execution result information 31 obtained by executing the test related to the action for the action target having the predetermined action condition, the condition change which is the change in the action condition before and after the test. The result verification unit 42 calculates, based on the execution result information 31, the evaluation value obtained by evaluating the effect of the action. The reward distribution unit 43 calculates the change contribution degree, which is the degree of contribution of the condition change to the evaluation value. Therefore, since the evaluation result of the action condition on which the test is not performed can be interpolated based on the change contribution degree, the new action can be more efficiently planned based on the execution result of the test for the limited action conditions.

In the present embodiment, the test is the AB test in which the action is implemented only on the group A which is one of the group A and the group B obtained by dividing a set including a plurality of action targets. The result verification unit 42 calculates the action implementation result information 34 indicating, as the evaluation value, an action evaluation value corresponding to the group A and an environment evaluation value corresponding to the group B. Therefore, the effect of the action can be more appropriately evaluated.

In the present embodiment, the reward distribution unit 43 calculates an action change contribution degree, which is a change contribution degree with respect to the action evaluation value, and an environment change contribution degree, which is a change contribution degree with respect to the environment evaluation value. Therefore, the change contribution degree can be more appropriately evaluated.

In the present embodiment, the condition change tracking unit 41 newly defines the action condition when the action condition after the test is different from the predetermined action condition. Therefore, even if the action condition changes to an unexpected action condition or the like, the effect of the action can be more appropriately evaluated.

In the present embodiment, the new action planning support unit 44 outputs the action effect prediction information 36 obtained by predicting the implementation result of the new action based on the evaluation value and the change contribution degree. In this case, since the effect of the new action can be predicted in advance, the new action can be efficiently planned.

In the present embodiment, the new action planning support unit 44 predicts the action effect prediction information based on the evaluation value and the change contribution degree of the similar action of which at least one of the action content and the action condition matches that of the new action, among the implemented actions. Therefore, the effect of the new action can be more appropriately predicted.

In the present embodiment, the new action planning support unit 44 predicts, as the action effect prediction information, the evaluation value and the statistical value of the change contribution degree of the similar action. Therefore, the effect of the new action can be more appropriately predicted.

In the present embodiment, the new action planning support unit 44 displays the statistical value in a graph form. Therefore, the action planner who plans the new action can visually understand the action effect prediction information and appropriately evaluate the effect of the new action.

The embodiments of this disclosure described above are examples for the purpose of describing this disclosure, and the scope of this disclosure is not intended to be limited only to those embodiments. A person skilled in the art could have implemented this disclosure in various other embodiments without departing from the scope of this disclosure. For example, when identification information is described, expressions such as “identification information”, “ID”, “title”, and “name” are used, but the expressions can be replaced with one another. Although the information is described as having a table structure, the information may not have a table structure.

What is claimed is:

1. An action evaluation system, comprising:
a tracking unit configured to determine, based on an execution result obtained by executing a test related to an action for an action target having a predetermined action condition, a condition change which is a change in the action condition before and after the test;
a verification unit configured to calculate, based on the execution result, an evaluation value obtained by evaluating an effect of the action; and
a distribution unit configured to calculate a change contribution degree which is a degree of contribution of the condition change to the evaluation value.

2. The action evaluation system according to claim 1, wherein
the test is to implement the action only on one of two groups obtained by dividing a set including a plurality of the action targets, and
the verification unit is configured to calculate action implementation result information indicating, as the evaluation value, an action evaluation value obtained by valuating the execution result corresponding to the one of the two groups and an environment evaluation value obtained by evaluating the execution result corresponding to the other of the two groups.

3. The action evaluation system according to claim 2, wherein
the distribution unit is configured to calculates an action change contribution degree, which is a change contribution degree with respect to the action evaluation value, and an environment change contribution degree, which is a change contribution degree with respect to the environment evaluation value.

4. The action evaluation system according to claim 1, wherein
the tracking unit is configured to newly define the action condition when the action condition after the test is different from the predetermined action condition.

5. The action evaluation system according to claim 1, further comprising:
an action support unit configured to output action effect prediction information obtained by predicting a result of a new action, which is newly defined, based on the evaluation value and the change contribution degree.

6. The action evaluation system according to claim 5, wherein
the action support unit is configured to predict the action effect prediction information based on an evaluation value and a change contribution degree of a similar action of which at least one of an action content and an action condition matches that of the new action, among implemented actions, which are actions related to the test.

7. The action evaluation system according to claim 6, wherein
the action support unit is configured to predict, as the action effect prediction information, the evaluation value and a statistical value of the change contribution degree of the similar action.

8. The action evaluation system according to claim 7, wherein
the action support unit is configured to display the statistical value in a graph form.

9. An action evaluation method using an action evaluation system, comprising:
determining, based on an execution result obtained by executing a test related to an action for an action target having a predetermined action condition, a condition change which is a change in the action condition before and after the test;
calculating, based on the execution result, an evaluation value obtained by evaluating an effect of the action; and
calculating a change contribution degree which is a degree of contribution of the condition change to the evaluation value.

10. A non-transitory and tangible computer-readable recording medium in which a program to be executed by a computer, the program causes a computer to implement:
a tracking unit configured to determine, based on an execution result obtained by executing a test related to an action for an action target having a predetermined action condition, a condition change which is a change in the action condition before and after the test;
a verification unit configured to calculate, based on the execution result, an evaluation value obtained by evaluating an effect of the action; and
a distribution unit configured to calculate a change contribution degree which is a degree of contribution of the condition change to the evaluation value.
